(19) United States
(12) Patent Application Publication
(10) Pub. No.: US 2020/0130236 A1
(43) Pub. Date: Apr. 30, 2020

(54) METHOD AND APPARATUS FOR PRODUCING INJECTION-MOLDED COMPONENTS IN SINGLE-USE MOLDS AND METHOD AND APPARATUS FOR PRODUCING SINGLE-USE MOLDS

(71) Applicant: MOLD ONE UG, LUPBURG (DE)

(72) Inventor: CARL FRUTH, LUPBURG (DE)

(21) Appl. No.: 16/662,590

(22) Filed: Oct. 24, 2019

(30) Foreign Application Priority Data
Oct. 24, 2018 (DE) 10 2018 126 504.2

(51) Int. Cl. B29C 33/38; B29C 45/26

(52) U.S. Cl. CPC B29C 33/3892; B29C 45/26

(57) ABSTRACT

Injection-molded components are produced using single-use molds. In order to produce individual injection-molded components inexpensively, an injection mold constructed from two elements, namely a shell and a shell reinforcement, is used. The two elements of the injection mold are produced from materials that must have specific material properties, namely solubility and melting temperature. The selection of these materials depends on the material properties of the injection-molding material that is used.

### CROSS-REFERENCE TO RELATED APPLICATION

This application claims the priority, under 35 U.S.C. § 119, of German application DE 10 2018 126 504.2, filed Oct. 24, 2018; the prior application is herewith incorporated by reference in its entirety.

### BACKGROUND OF THE INVENTION

### Field of the Invention

The invention relates to the production of injection-molded components in single-use molds.

In injection molding, the injection-molding material is liquefied (plasticized) and injected under pressure into an injection mold (tool). The material then cools in the injection mold. The resulting injection-molded component (molded part) can then be removed from the injection mold. The cavity of the injection mold determines the shape of the completed component.

Injection-molding methods that are common nowadays generally serve for inexpensive production of identical molded parts in large numbers. Because of the high cost for the injection mold, the cost-effectiveness threshold is often not reached until a few thousand parts are involved. On the other hand, injection molds can be used to produce as many as several million parts.

Because of increasing customer demand for individually configured products that are exactly tailored to individual desires, single or special fabrication runs are playing an increasingly major role in production.

At present, no method is yet known that makes possible inexpensive production of injection-molded parts in small numbers, in particular as a single run (lot size=1). Production costs for injection-molded components that are manufactured using individually fabricated molds usable only once (single-use molds) are extremely high. The use of injection-molding technology is therefore, as a rule, not cost-effective in such cases. A shift is then made to alternative production methods, so that the special advantages of injection molding, in particular the almost unrestricted selection of shape and surface structure as well as the high precision that can be achieved, are not available.

### SUMMARY OF THE INVENTION

An object of the present invention is to furnish a technique that allows individual injection-molded components to be produced inexpensively.

This object is achieved by way of the subjects of the independent claims. Advantageous embodiments of the invention are described in the dependent claims.

With the foregoing and other objects in view there is provided, in accordance with the invention, a method for producing a single-use mold for an injection-molding operation. In the injection-molding operation an injection-molded component is produced using an injection-molding material. The method includes creating from a soluble shell material, a shell that forms a cavity for the injection-molded component, or creating, from the soluble shell material, a partial shell that forms the cavity for the injection-molded component. The shell is created using the partial shell and the soluble shell material is soluble in a solvent in which the injection-molding material does not dissolve. From a meltable reinforcement material, a shell reinforcement is created that substantially completely surrounds the shell. The meltable reinforcement material has a lower melting point than the injection-molding material.

With the foregoing and other objects in view there is further provided, in accordance with the invention, an apparatus for producing a single-use mold for an injection-molding operation. In the injection-molding operation an injection-molded component is produced using an injection-molding material. The apparatus contains means for creating, from a soluble shell material, a shell that forms a cavity for the injection-molded component or creating, from the soluble shell material, a partial shell that forms the cavity for the injection-molded component, and for creating the shell utilizing the partial shell. In addition, a means for creating, from a meltable reinforcement material, a shell reinforcement that substantially completely surrounds the shell, is further provided. The meltable reinforcement material has a lower melting point than the injection-molding material.

The advantages and embodiments explained below in conjunction with the method also apply, mutatis mutandis, to the apparatuses and subjects according to the present invention, and vice versa.

The basic idea common to all subjects of the independent claims is the use of a special injection mold that contains a shell and a shell reinforcement that mechanically reinforces the shell, the shell being created entirely or partly individually, preferably using an additive production method. The injection-molded component is manufactured using that injection mold. The component is then unmolded. Analogously to the two-step construction of the injection mold, unmolding also occurs in two steps. First the shell reinforcement is removed, specifically by melting away the reinforcement material, before the shell or partial shell is then removed, specifically by dissolving the shell material in a solvent. It is essential, already in the context of creating the injection mold, that the shell material be soluble in a solvent in which the injection-molding material is much more difficult to dissolve or does not dissolve, and that the reinforcement material have a lower melting point than the injection-molding material. This ensures that the injection-molded component is not damaged during the unmolding operation. The material used for the shell reinforcement can be captured after being melted away, and reused. It is thus only for the inner part of the injection mold (the shell) that new material must be used in each case. Because the shell is reinforced before it is used, it itself needs to have only a minimal thickness. The material outlay for constructing the shell is therefore very low. The result is that the injection mold, i.e. the element whose production is typically associated with very high costs, can thereby be created very inexpensively.

The invention furnishes a technique with which it is possible, in a simple and comparatively inexpensive manner, to manufacture a completely individualizable injection-molded component or a partly individualizable injection-molded component, depending on whether the entire shell or only part of the shell was previously individually produced. The utilization of a single-use injection mold already represents an innovation of itself.

Other features which are considered as characteristic for the invention are set forth in the appended claims.

Although the invention is illustrated and described herein as embodied in a production of injection-molded components in single-use molds, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a facility for additive manufacturing, having a control unit according to the invention;

FIG. 2 is an illustration that depicts a partly individualized shell, on the left with a detached partial shell and on the right with it installed;

FIG. 3 is an illustration that depicts a completely individualized shell;

FIG. 4 is an illustration that depicts a single-use mold having a shell and a shell reinforcement, before the injection-molding operation;

FIG. 5 is an illustration that shows a single-use mold having a shell and a shell reinforcement, during the injection-molding operation;

FIG. 6 is an illustration that shows a completely unmolded injection-molded component; and

FIG. 7 is an illustration that shows an injection-molding apparatus and a facility for unmolding.

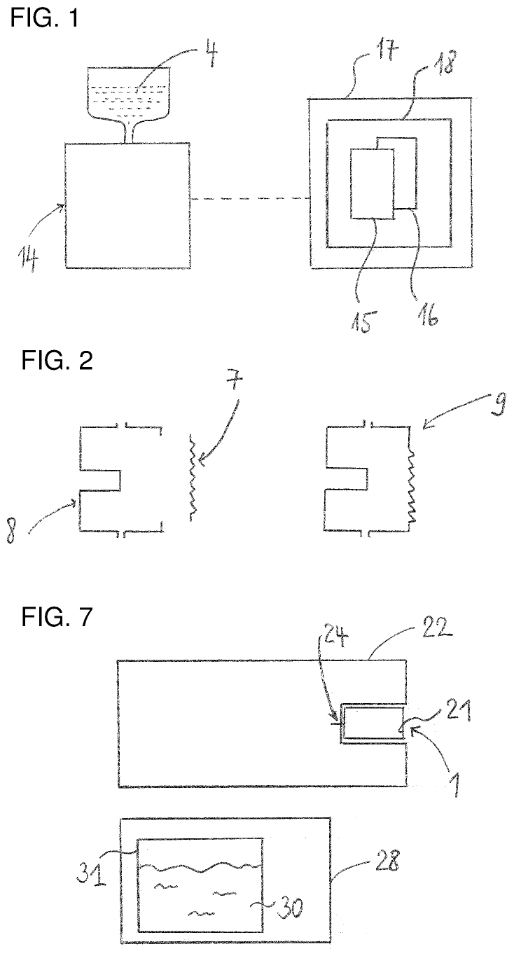

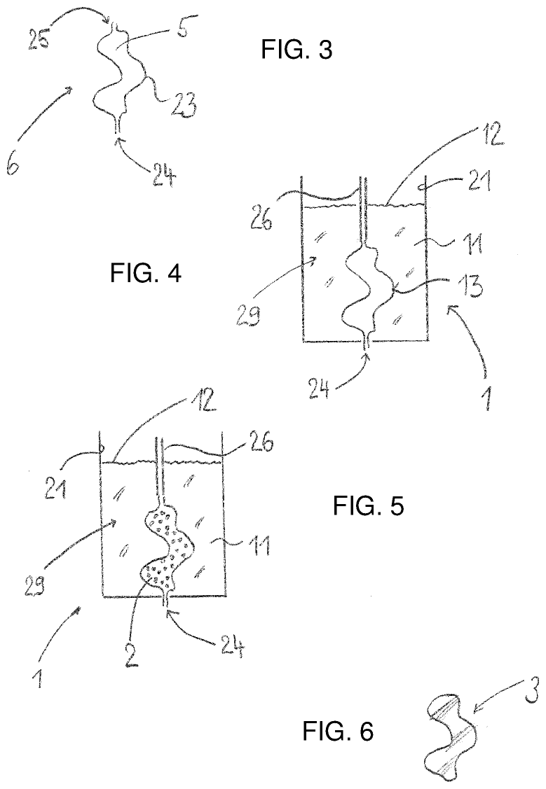

### DETAILED DESCRIPTION OF THE INVENTION

All the figures show the invention not accurately to scale, merely schematically, and only with its essential constituents. Identical reference characters correspond to elements having an identical or comparable function.

The method described below serves for production of a single-use mold 1 for an injection-molding operation in which an injection-molded component 3 is produced using an injection-molding material 2. The method encompasses two sub-steps.

In a first sub-step, either a shell 6 constituting cavity 5 for an injection-molded component 3 is created from a soluble shell material 4, or a part 7 of a shell 9 constituting the cavity 5 for the injection-molded component 3 is created from the soluble shell material 4, and the shell 9 is then created using the partial shell 7. The shell material 4 is soluble in a solvent 30 in which injection-molding material 2 does not dissolve.

In a second sub-step, a shell reinforcement 12 that substantially completely surrounds shell 6, 9 is created from a meltable reinforcement material 11, reinforcement material 11 having a lower melting point than the injection-molding material 2.

The solid shell 6, 9 (molding shell) is defined and constructed in such a way that it defines the external shape of the subsequent injection-molded component 3, or encases the subsequent injection-molded component 3. Either the entire shell 6, but at least a shell part 7, is fabricated individually, i.e. as a single fabrication run (lot size=1). In other words, either the entire component 3 is individualized, i.e. it is a completely individualized single piece, or only part of component 3 that is to be produced by injection molding is individually produced, for example a nameplate, a marking label, or the like, while the remaining parts of component 3 stay the same.

The shell 6, 9 is constructed either entirely or partly from the soluble shell material 4, i.e. the shell material 4 that is used for the entire shell 6 or partial shell 7 is soluble in the preferably liquid solvent 30, for example caustic soda, water, or the like. The solvent 30 is always one in which the injection-molding material 2 does not dissolve, or is much more difficult to dissolve than the shell material 4. The shell material 4 is selected so that it readily dissolves in the solvent 30. At the same time, the shell material 4 is selected so that it preferably dissolves completely, or almost completely, in the solvent 30.

A first material pairing to be considered therefore always exists, containing on the one hand the shell material 4 used for the construction of the shell 6 or the partial shell 7, and on the other hand the injection-molding material 2 used to produce the injection-molded component 3. In the context of this material pairing, several different shell materials 4 can be associated with the given injection-molding material 2, and likewise the given shell material 4 can be associated with several injection-molding materials 2. These materials 2, 4 that respectively interact in a pairing are coordinated with another in terms of their solubility. More precisely, the solubility of the shell material 4 in the given solvent 30 under the same conditions is considerably greater, preferably greater by at least a factor of two, than the solubility of the injection-molding material 2 that is used. It is very particularly advantageous if the solubility of the shell material 4 is greater by a factor of at least 10 than the solubility of the injection-molding material 2.

The shell material 4 is, for example, a photopolymer soluble in caustic soda. The melting point of the shell material 4 is advantageously sufficiently high that it withstands the elevated temperature during the injection-molding operation.

If only a shell part 7 is being created, that the shell part 7 is then used to generate the complete shell 9. The individualized partial shell 7 is combined for that purpose, using suitable connecting means, with a basic shell 8 (permanent tool). Typically, the individual partial shell 7 supplements the standardized, repeatedly usable basic shell 8, so that combining the two shell elements 7, 8, as a rule by attaching partial shell 7 to basic shell 8, results in the desired complete, partly individualized shell 9. Provision can also be made that several individualized shell parts 7 are created, and are used alone or in conjunction with a basic shell 8 to create the complete shell 9.

In a subsequent step, the complete shell 6, 9 that is thereby created is equipped with the shell reinforcement 12. Once the shell reinforcement 12 has been created, it preferably abuts against an outer side 13 of the shell 6, 9 so that the shell 6, 9 is mechanically reinforced. In other words, the shell 6, 9 is substantially completely surrounded by the shell reinforcement 12. Reinforcement material 11 that is used is meltable, i.e. it melts upon exceedance of a defined temperature (melting temperature).

The meltable reinforcement material 11 that is used to create shell reinforcement 12 melts at a lower temperature than injection-molding material 2. In other words, it is low-melting in such a way that it has a lower melting point than injection-molding material 2. The injection-molded component 3 produced from the higher-melting injection-molding material 2 is thus not affected upon unmolding, and remains undamaged. In the interest of process reliability, the reinforcement material 11 is also selected in such a way that it melts preferably completely, or almost completely, upon attaining a defined low temperature.

A second material pairing to be considered therefore always exists, containing on the one hand reinforcement material 11 used to build the shell reinforcement 12, and on the other hand injection-molding material 2 used in the injection-molding operation. For purposes of this material pairing, several different reinforcement materials 11 can be associated with a given injection-molding material 2, and the given reinforcement material 11 can also be associated with several injection-molding materials 2. These materials 2, 11 that respectively interact in a pairing are coordinated with one another in terms of their melting points. More precisely, the melting temperature of reinforcement material 11 is always considerably lower, preferably at least 5 Kelvins lower, than the melting temperature of injection-molding material 2. It is very particularly advantageous if the melting temperature of reinforcement material 11 is at least 30 Kelvins lower than the melting temperature of injection-molding material 2.

The reinforcement material 11 is, for example, Wood's metal or a similar material having a lower melting point. Wood's metal is a bismuth alloy that melts at approximately 60° C. Hot water is therefore sufficient to melt it.

The reinforcing compound used to create the shell reinforcement 12 is preferably reusable, i.e. once the shell reinforcement 12 has melted away during the unmolding of component 3, the reinforcement material 11 can be completely or at least almost completely reused for the creation of another shell reinforcement 12.

According to a preferred embodiment of the invention, the shell 6 or the partial shell 7 is constructed by additive manufacturing.

The shell 6 or the partial shell 7 is preferably created by means of an additive manufacturing method, in particular a layer building method in which layers of the build material 4 are applied successively onto one another, such that before application of the respective next layers, those locations in the respective layers which correspond to the cross section of the shell 6, 7 that is to be manufactured are selectively solidified, for example by local heating of a powdered raw layer material 4 using a radiation source. A variety of additive manufacturing methods and facilities 14 for carrying them out are known from the existing art, for example stereolithography, selective laser melting, selective mask sintering, etc.

Additive building of this kind is advantageous in particular with complex component shapes, with which it is impossible, or possible only with a great deal of production complexity, to construct the shell 6 or the partial shell 7 by means of conventional methods (e.g. milling).

According to a preferred embodiment of the invention, the method for producing the single-use mold 1 encompasses the previous creation of a data model 15 that defines the shell 6 or the partial shell 7, and/or creation of control data 16 for controlling the facility 14 for creating the shell 6 or the partial shell 7 on the basis of the data model 15 that defines the shell 6 or the partial shell 7.

The control data 16 are used to control the facility 14 for additive manufacturing of the shell 6 or partial the shell 7, in particular a layer building facility. The control data 16 encompass the data model 15 for describing the shell 6 or the partial shell 7 that is to be produced, or are generated using such a data model 15. The data model 15 and/or the control data 16 are created, preferably in computer-assisted fashion in a control unit 17 that is preferably connected or connectable to the facility 14, using a suitable software program and in either fully or partly automated fashion, on the basis of target data that describe the shape and other properties of injection-molded component 3 that is to be produced.

Using the data model 15 previously generated with the aid of a computer program 18, optionally using measured data or sensor data, control data for controlling the layer building facility 14 are generated preferably in a control unit 17 of the layer building facility 14. The layer building facility 14, controlled with the use of those control data 16, generates, by executing a layer building method, the shell component 6, 7 that is described by the data model 15.

The data model 15 and/or the control data 16 are advantageously formulated in a universally usable, standardized data format that is usable regardless of the building method that is selected.

According to a preferred embodiment of the invention, the shell reinforcement 12 is created by encasing the shell 6, 9 in a reinforcement compound 11.

The shell reinforcement 12 is preferably created not physically separately from the shell 6, 9 but instead directly on the completely created shell 6, 9, namely by surrounding or enclosing the shell 6, 9. In a preferred embodiment of the invention, shell reinforcement 12 is created by encasing the solid, manufactured shell 6, 9 in a liquid reinforcement compound 11.

It is particularly advantageous if the reinforcement compound 11 is introduced into a receiving vessel 21 in which the shell 6, 9 is arranged, the receiving vessel 21 preferably being insertable into an injection-molding apparatus 22 suitable for executing the injection-molding operation.

The shell 6, 9 is therefore preferably encased with the reinforcement compound 11 in such a way that the shell 6, 9 is arranged in a, for example, cylindrical vessel 21, and the vessel 21 is filled with the (hot) liquid reinforcement compound 11. The vessel 21 is preferably filled sufficiently such that the shell 6, 9 is completely covered by the reinforcement compound 11.

A receiving vessel 21 of this kind, in the form of an injection-molding cartridge, serves for simple handling of the completed injection mold 1. A cartridge 21 produced in such a fashion can be easily and inexpensively stored, transported, and placed into the injection-molding apparatus 22, and removed again from the injection-molding apparatus 22. In other words, the receiving vessel 21 is preferably embodied as an easily handleable replaceable or exchangeable part for the injection-molding apparatus 22.

The use of the receiving vessel 21 is preferably necessary for stability reasons. If the shell reinforcement is embodied to be sufficiently solid, however, reinforcement material 11 would also, after it had solidified, be sufficiently stable to accept or withstand the injection pressure even in the absence of receiving vessel 21. The use of injection mold 1 in the interior of cartridge 21 is therefore not obligatorily necessary. The completed single-use mold 1, whose external shape depends on the conformation of receiving vessel 21, can also be integrated in a different manner, in particular without cartridge 21, into the injection-molding apparatus 22. It is nevertheless advantageous for execution of the method if the receiving vessel 21, in whose interior injection mold 1 has been completed by the application of shell reinforcement 12, is simultaneously used for the injection-molding operation; in other words, the injection mold 1 is no longer removed from receiving vessel 21 but remains therein until the injection-molding operation is complete.

The apparatus described below serves for production of a single-use mold 1 for an injection-molding operation, in which operation an injection-molded component 3 is produced using an injection-molding material 2, in particular in accordance with the method previously described.

The apparatus either encompasses means 14, 15, 16, 17, 18 for creating, from the soluble shell material 4, the shell 6 that forms the cavity 5 for the injection-molded component 3. Or the apparatus encompasses means 14, 15, 16, 17, 18 for creating, from the soluble shell material 4, the part 7 of the shell 9 that forms the cavity 5 for an injection-molded component 3, and means for creating the shell 9 utilizing the partial shell 7. In both cases, the means 14, 15, 16, 17, 18 are embodied in such a way that the shell material 4 used to create the shell 6, 7 is soluble in the solvent 30 in which the injection-molding material 2 is insoluble, or is soluble only with much greater difficulty.

The apparatus furthermore encompasses means for creating, from the meltable reinforcement material 11, the shell reinforcement 12 that substantially completely surrounds the shell 6, 9, the reinforcement material 11 having a lower melting point than the injection-molding material 2.

The single-use mold 1 is described below for an injection-molding operation in which the injection-molded component 3 is produced using the injection-molding material 2. The single-use mold 1 is produced either in accordance with the method described above or with the aid of the apparatus described above.

The single-use mold 1 is characterized in that it encompasses the shell 6, 9 and the shell reinforcement 12 that substantially completely encloses the shell 6, 9, the shell 6, 9 being made completely or partly from the soluble shell material 4 that is soluble in the solvent 30 in which the injection-molding material 2 does not dissolve, and the shell reinforcement 12 being made of a meltable reinforcement material 11 that has a lower melting point than the injection-molding material 2.

In a particularly simple embodiment of the invention, the single-use mold 1 (single-use tool) is made up exclusively of the shell 6, 9 and the shell reinforcement 12.

According to a preferred embodiment of the invention, the wall thickness of the shell 6 or of the partial shell 7 is between 0.025 and 30 mm. A wall thickness of between 0.1 and 2 mm is particularly preferred.

The shell 6, 7 is comparatively thin. A minimum thickness for shell wall 23 (shell thickness) is desirable. The wall is preferably dimensioned to be only sufficiently thick that shell 6, 7 is independently stable. The wall thickness is furthermore selected so that it withstands without damage the application of shell reinforcement 12, in particular resists the pressure as shell 6, 7 is encased with shell reinforcement 12. The wall thickness is furthermore preferably selected so that the shell 6, 7 is self-supporting. The mechanical strength of the shell 6, 7 required for the injection-molding operation is not attained, however, until the shell 6, 9 is surrounded by the shell reinforcement 12.

The result of the thin wall thickness of the shell wall 23 is that comparatively little material is required for the individually produced shell 6 or partial shell 7. Production costs for the injection mold 1 are, as a result, comparatively low. In combination with the reusable reinforcement material 11 (see below), the costs for producing component 3 are low compared with other production methods, even though injection mold 1 (the shell reinforcement 12 and the shell 6 or partial shell 7) is completely or at least partly destroyed upon unmolding of component 3, i.e. injection mold 1 as a whole is always a single-use mold, in other words the lot size is always equal to 1.

The thin wall thickness of shell 6, 7 also makes possible particularly rapid dissolution of shell material 4 during the unmolding of component 3.

According to a preferred embodiment of the invention, the shell 6 is configured in one piece.

If the complete shell 6, and not just a partial shell 7, is created individually, the complete shell 6 is then preferably constructed in one piece.

When only a partial shell 7 is created, on the other hand, the complete shell 9 is then embodied in multiple parts, as already described above. In this case, individually fabricated insert parts or the like, which were previously individually fabricated and constitute the shell parts 7, can be introduced into a basic shell 8 before the shell 9 is reinforced, for example, by encasing the shell 9 with the reinforcement material 11.

According to a preferred embodiment of the invention, the shell 6, 9 has at least one opening.

The shell 6, 9 has at least one opening 24, namely the opening for subsequent filling, through which, in the context of the injection-molding operation, the melt 2 is forced at high pressure into the shape-imparting cavity 5 of the injection mold 1. The opening 24 is preferably created at the same time the shell is produced. The opening 24 can, however, also be produced in an intermediate step, for example by drilling or milling, after shell manufacture and before the application of shell reinforcement 12.

The shell 6, 9 can comprise several, in particular two, openings, i.e. in addition to the opening 24 for filling, an opening 25 for venting, in particular for a venting conduit 26 attachable to the shell 6, 9 in order to vent the shell 6, 9 during the injection-molding operation.

Further the opening 25 can, however, also be used for a vacuum conduit in order to generate a vacuum in an interior 5 of the shell 6, 9 before the injection-molding operation. The process reliability of the filling operation in the context of injection molding can thereby be enhanced.

The invention also relates to the use of a single-use mold, in particular a single-use mold 1 described above, to produce an injection-molded component 3 using an injection-molding operation.

The method described below serves for production of the injection-molded component 3 with the aid of an injection-molding operation. What is used in this context is preferably the single-use mold 1 that has been produced using the method described above or the apparatus described above.

The method encompasses creating the injection-molded component 3 by injecting a molding compound, made of the injection-molding material 2, into the single-use mold 1; and unmolding the injection-molded component 3. The unmolding includes both the removal of the shell reinforcement 12 by melting away the reinforcement material 11, and the removal of the shell 6 or partial shell 7 by dissolving the shell material 4 in the solvent 30.

This is the injection-molding method in a narrower sense. In a broader sense, the overall method also encompasses the production of the single-use mold 1 as described above.

The injection-molded component 3 is created from an injection-molding material 2 by injecting the molding compound into the injection mold 1 constituted by the reinforced shell.

The injection-molding material 2 that is used has a higher melting point than the reinforcement material 11 and is not dissolved, or is dissolved only with a great deal more difficulty, by solvent 30 of shell material 4.

Unmolding of the injection-molded component 3 is accomplished on the one hand by removing the shell reinforcement 12, i.e. by melting away reinforcement material 11 at a temperature below the melting point of injection-molding material 2. A heat treatment of the shell reinforcement 12 is performed for that purpose. A variety of types of heat treatment or heat delivery to the shell reinforcement 12, which are familiar to one skilled in the art, can be applied in this context.

On the other hand, unmolding is accomplished by removing the shell 6 or partial shell 7, specifically by dissolving the shell material 4 in the solvent 30 in which the injection-molding material 2 does not dissolve or dissolves very much less readily. The shell 6, 9, from which the shell reinforcement 12 has been removed, is preferably dipped into a solvent bath for that purpose. A variety of other possibilities for furnishing the solvent 30 for dissolving the shell material 11 are familiar to one skilled in the art and can be applied to the shell 6, 9.

If only an individualized partial shell 7 is being used, it is dissolved and the remaining basic shell 8, which is preferably embodied as a conventional permanent tool, is opened in known fashion in order to release the injection-molded component 3. In this case the merely partly individualized shell 9 also does not need to be completely surrounded by the reinforcement material 11. It is sufficient if only that region of the shell 9 which contains the individualized partial shell 7 is equipped with the shell reinforcement 12. Correspondingly, in the context of unmolding it is also necessary to melt away and dissolve the shell reinforcement 12 and the partial shell 7 only in that region of the shell 9. In other words, the unmolding operation, as well as the application of the shell reinforcement 12, can be limited locally to the region of the partial shell.

Unmolding is preferably accomplished in a facility separate from the injection-molding apparatus 22. For that purpose, the injection-molded component 3, which is preferably located in an interior 29 of the injection-molding cartridge 21 or in a vessel configured in another manner, is removed from the injection-molding apparatus 22 and delivered to a facility 28 for unmolding and/or post-treatment.

The injection-molded component 3 obtained after unmolding can then be used as a completed component, or it can serve as a component for creating a multi-component combination component.

In a very simple case, unmolding is accomplished in hot water, the water serving first as a heat transfer medium for introducing melting energy into the shell reinforcement 12 and thus for melting away the reinforcement material 11, and then as the solvent 30 for dissolving the shell material 4.

According to a preferred embodiment of the invention, the reinforcement material 11 of the shell reinforcement 12 which is melted during the unmolding of the injection-molded component 3 is reused at least in part for the creation of the shell reinforcement 12 upon production of a further single-use mold 1.

Preferably, all or almost all of the reinforcement material 11 that was melted away is reused, optionally after purification of the material in an intermediate step.

The apparatus described below serves for production of the injection-molded component 3 with the aid of an injection-molding operation using the single-use mold 1 as described above.

The apparatus encompasses means 22 for injecting a molding compound, made of the injection-molding material 2, into the single-use mold 1 in order to create the injection-molded component 3. The apparatus furthermore encompasses means 28 for removing the shell reinforcement 12 by melting away the reinforcement material 11, and means 28 for removing the shell 6 or partial shell 7 by dissolving the shell material 4 in the solvent 30 in order to unmold the injection-molded component 3.

The means 22, 28 can be embodied in facilities separated from one another. In particular, the means 28 for unmolding can be arranged physically separately from the injection-molding apparatus 22. An immersion bath 31 having a heated solvent 30 for carrying out unmolding can be arranged, for example, in an auxiliary space adjacent to the injection-molding apparatus 22. Unmolding can take place not only physically separately, but also with a large offset in time, from the injection-molding operation.

Lastly, the invention also relates to an injection-molded component 3 produced in accordance with the above-described method or with the above-described apparatus.

The invention further relates to the injection-molding apparatus 22 for producing the injection-molded component 3 with the aid of an injection-molding operation, embodied for changeable reception of single-use molds, in particular of the single-use molds 1 described above. A changeable or quick-change system of this kind can be realized particularly advantageously with the above-described cartridges 21, especially if cartridges 21 have a standardized size. This does not exclude the existence, in the interest of minimizing material usage for the reinforcement material 11, of cartridges 21 in different standard sizes, for which purpose the changeable system of injection-molding apparatus 22 can furnish receiving devices of different sizes for cartridges 21.

The invention also relates to a method for unmolding, from an above-described single-use mold 1, the injection-molded component 3 produced with the aid of the injection-molding operation, in which method the shell reinforcement 12 is removed by melting away the reinforcement material 11, and the shell 6 or partial shell 7 is removed by dissolving the shell material 4 in the solvent 30.

The process steps of a complete cycle are indicated below:

a) creating the data model 15 that defines the shell 6 and/or partial shell 7, and/or creating the control data 16 for controlling a facility 14 for creating the shell 6 or partial shell 7 on the basis of the data model 15 that defines the shell 6 or partial shell 7;
b) creating the shell 6, which forms the cavity 5 for the injection-molded component 3, from a soluble shell material 4 by additive manufacturing, or creating a part 7 of the shell 9, which forms the cavity 5 for the injection-molded component 3, from a soluble shell material 4 by additive manufacturing, and creating the shell 9 utilizing the partial shell 7;
c) creating, from the meltable reinforcement material 11, the shell reinforcement 12 that substantially completely surrounds the shell 6, 9, the reinforcement material 11 having a lower melting point than the injection-molding material 2;
d) creating the injection-molded component 3 by injecting into the single-use mold 1 a molding compound made of the injection-molding material 2;
e) unmolding the injection-molded component 3 by removing the shell reinforcement 12 by melting away the reinforcement material 11, and removing the shell 6 or partial shell 7 by dissolving the shell material 4 in the solvent 30; and
f) at least partly reusing the reinforcement material 11 of the shell reinforcement 12, which was melted away during the unmolding of the injection-molded component 3, to create the shell reinforcement 12 upon production of the further single-use mold 1.

In summary, the invention relates to the production of injection-molded components 3 in single-use molds 1. In order to produce the individual injection-molded components 3 inexpensively, the use of the injection mold 1 constructed from two elements (the shell 6, 7 and the shell reinforcement 12) is proposed. The two elements of the injection mold 1 are produced from materials that must have specific material properties (solubility and melting temperature). The selection of these materials 4, 11 depends on the material properties of the injection-molding material 2 that is used. Suitable materials and material combinations, including ones other than those recited above, can be selected by one skilled in the art in consideration of the requirements described, and of their suitability for the injection-molding technique.

Portions of the methods according to the present invention can be carried out in computer-assisted fashion. This relates, inter alia, to the method for generating the injection mold 1, in particular therein to the generation of the data set 15 to describe the shell 6 or hull part 7, and to the generation of the control data 16. This relates furthermore to the control of the facility 14 for additive manufacturing for the production of the injection mold 1, and to the control of an injection-molding apparatus 22 for carrying out the injection-molding operation for generating the injection-molded component 3. An apparatus suitable for carrying out the method according to the present invention can be implemented substantially by furnishing a suitable computer program.

All features presented in the description and in the claims which follow, and depicted in the drawings, can be essential to the invention both individually and in any combination with one another.

### LIST OF REFERENCE CHARACTERS

1 Injection mold, single-use mold
2 Injection-molding compound, injection-molding material
3 Injection-molded component
4 Shell material
5 Cavity
6 Completely individualized shell
7 Individualized partial shell
8 Standardized basic shell
9 Partly individualized shell
10 (unassigned)
11 Reinforcement compound, reinforcement material
12 Shell reinforcement
13 Outer side of shell
14 Facility for additive manufacturing
15 Data model
16 Control data
17 Control unit, computation unit
18 Computer program
19 (unassigned)
20 (unassigned)
21 Receiving vessel, cartridge
22 Injection-molding apparatus
23 Shell wall
24 Opening, filling
25 Opening, venting
26 Venting conduit
27 (unassigned)
28 Unmolding facility
29 Vessel interior
30 Solvent
31 Immersion bath with hot water

1. A method for producing a single-use mold for an injection-molding operation, in the injection-molding operation an injection-molded component is produced using an injection-molding material, which comprises the steps of:
performing one of:
creating, from a soluble shell material, a shell that forms a cavity for the injection-molded component; or
creating, from the soluble shell material, a partial shell that forms the cavity for the injection-molded component, and creating the shell using the partial shell, the soluble shell material being soluble in a solvent in which the injection-molding material does not dissolve; and
creating, from a meltable reinforcement material, a shell reinforcement that substantially completely surrounds the shell, the meltable reinforcement material having a lower melting point than the injection-molding material.

2. The method according to claim 1, which further comprises constructing the shell or the partial shell by additive manufacturing.

3. The method according to claim 1, which further comprises:
creating a data model that defines the shell or the partial shell; and/or
creating control data for controlling a facility for creating the shell or the partial shell on a basis of the data model that defines the shell or the partial shell.

4. The method according to claim 1, which further comprises creating the shell reinforcement by encasing the shell in the meltable reinforcement compound.

5. The method according to claim 4, which further comprises introducing the meltable reinforcement compound into a receiving vessel in which the shell is disposed, the receiving vessel being insertable into an injection-molding apparatus suitable for executing the injection-molding operation.

6. An apparatus for producing a single-use mold for an injection-molding operation, in the injection-molding operation an injection-molded component is produced using an injection-molding material, the apparatus comprising:
means for:
creating, from a soluble shell material, a shell that forms a cavity for the injection-molded component; or
creating, from the soluble shell material, a partial shell that forms the cavity for the injection-molded component, and for creating the shell utilizing the partial shell; and
means for creating, from a meltable reinforcement material, a shell reinforcement that substantially completely surrounds the shell, the meltable reinforcement material having a lower melting point than the injection-molding material.

7. A single-use mold for an injection-molding operation in which an injection-molded component is produced from an injection-molding material, the single-use mold comprising:
a shell being made completely or partly from a soluble shell material being soluble in a solvent in which the injection-molding material does not dissolve; and
a shell reinforcement that substantially completely encloses said shell, said shell reinforcement being made of a meltable reinforcement material that has a lower melting point than the injection-molding material.

8. The single-use mold according to claim 7, wherein:
a wall thickness of said shell or a part of said shell is between 0.025 and 30 mm; and/or
said shell is formed in one piece; and/or
said shell has at least one opening formed therein.

9. The single-use mold according to claim 8, wherein said wall thickness is between 0.1 and 2 mm.

10. A method of using a single-use mold, which comprises the steps of:
performing one of:
providing the single-use mold to contain a first shell being made completely or partly from a first soluble shell material being soluble in a solvent in which an injection-molding material does not dissolve and a first shell reinforcement that substantially completely encloses the first shell, the first shell reinforcement being made of a first meltable reinforcement material that has a lower melting point than the injection-molding material;
creating the single-use mold with a second shell formed from a second soluble shell material, the second shell having a cavity formed therein for the injection-molded component, and creating, from a second meltable reinforcement material, a second shell reinforcement that substantially completely surrounds the second shell, the second meltable reinforcement material having a lower melting point than the injection-molding material; or
creating the single-use mold with a partial shell that forms the cavity for the injection-molded component from a third soluble shell material, and creating a third shell using the partial shell, the third soluble shell material being soluble in the solvent in which the injection-molding material does not dissolve and creating, from a third meltable reinforcement material, a third shell reinforcement that substantially completely surrounds the third shell, the third meltable reinforcement material having a lower melting point than the injection-molding material; and
producing the injection-molded component by performing an injection-molding operation.

11. A method for producing an injection-molded component with an aid of an injection-molding operation, which comprises the steps of:
performing one of:
providing a single-use mold containing a shell being made completely or partly from a soluble shell material being soluble in a solvent in which an injection-molding material does not dissolve and a shell reinforcement that substantially completely encloses the shell, the shell reinforcement being made of a meltable reinforcement material that has a lower melting point than the injection-molding material;
creating the single-use mold with the shell having a cavity formed therein for the injection-molded component from the soluble shell material, and creating from the meltable reinforcement material, the shell reinforcement that substantially completely surrounds the shell, the meltable reinforcement material having a lower melting point than the injection-molding material; or
creating the single-use mold to have a partial shell having the cavity formed from the soluble shell material, and creating the shell using the partial shell, the soluble shell material being soluble in the solvent in which the injection-molding material does not dissolve and creating, from the meltable reinforcement material, the shell reinforcement that substantially completely surrounds the shell, the meltable reinforcement material having a lower melting point than the injection-molding material;
creating the injection-molded component by injecting a molding compound, made of the injection-molding material, into the single-use mold; and
unmolding the injection-molded component by removing the shell reinforcement by melting away the reinforcement material, and removing the shell or the partial shell by dissolving the shell material in the solvent.

12. The method according to claim 11, wherein the reinforcement material of the shell reinforcement which is melted during the unmolding of the injection-molded component is reused at least in part for a creation of a new shell reinforcement upon production of a new single-use mold.

13. An apparatus for producing an injection-molded component with an aid of an injection-molding operation utilizing a single-use mold having a shell being made completely or partly from a soluble shell material being soluble in a solvent in which an injection-molding material does not dissolve and a shell reinforcement that substantially completely encloses the shell, the shell reinforcement being made of a meltable reinforcement material that has a lower melting point than the injection-molding material, the apparatus comprising:
first means for injecting a molding compound, made of the injection-molding material, into the single-use mold in order to create the injection-molded component;
second means for removing the shell reinforcement by melting away the reinforcement material; and
third means for removing the shell or a partial part of the shell by dissolving the soluble shell material in the solvent in order to unmold the injection-molded component.

14. An injection-molding apparatus for producing an injection-molded component with an aid of an injection-molding operation, the injection-molding apparatus comprising:
a housing embodied for changeable reception of single-use molds, the single-use molds each containing a shell being made completely or partly from a soluble shell material being soluble in a solvent in which an injection-molding material does not dissolve and a shell reinforcement that substantially completely encloses the shell, the shell reinforcement being made of a meltable reinforcement material that has a lower melting point than the injection-molding material.

15. A method for unmolding, from a single-use mold an injection-molded component produced with an aid of an injection-molding operation, the single-use mold having a shell being made completely or partly from a soluble shell material being soluble in a solvent in which an injection-molding material does not dissolve and a shell reinforcement that substantially completely encloses the shell, the shell reinforcement being made of a meltable reinforcement material that has a lower melting point than the injection-molding material, which comprises the steps of:
removing the shell reinforcement by melting away the meltable reinforcement material; and
removing the shell or a part of the shell by dissolving the soluble shell material in a solvent.
